(19) United States
(12) Patent Application Publication
(10) Pub. No.: US 2004/0265412 A1
(43) Pub. Date: Dec. 30, 2004

(54) Device for extruding flowable compounds and method for producing such a device

(76) Inventor: Filipp Peck, Weinstadt-Beutelsbach (DE)

Correspondence Address: BURNS DOANE SWECKER & MATHIS L L P, POST OFFICE BOX 1404, ALEXANDRIA, VA, 22313-1404, US

(21) Appl. No.: 10/484,635

(22) PCT Filed: Jul. 4, 2002
(86) PCT No.: PCT/EP02/07400

(30) Foreign Application Priority Data
Jul. 27, 2001 (DE) 101 38 334.7

(51) Int. Cl. B29C 39/02

(52) U.S. Cl. 425/375

(57) ABSTRACT

A rotary drop former wherein a flowable mass is extruded as droplets from an aperture of a perforated rotary drum which is aligned with a feed device disposed inside the drum. A radial outer end of each aperture is surrounded by a groove formed in an outer periphery of the drum. The groove intersects a radially outer end of its respective aperture to form therewith a tear-off edge which promotes release of the droplets from the drum.

### BACKGROUND OF THE INVENTION

The invention relates to a device for extruding a flowable mass, which is fed into the lower area of the interior of a rotatable cylindrical drum whereby said mass is forced through a plurality of radially running apertures aligned with the feed space and whereby said mass exits preferably in the shape of droplets which solidify on a belt moving under the drum. The invention relates also to a method for manufacturing such a device.

A device of this type is disclosed in EP 0 145 839 A2. In such so-called rotor drop shapers, wherein the material to be extruded is forced out at the bottom of a rotating perforated drum, there cannot be prevented during processing of certain viscous materials that the material pushed out of the apertures is not separated completely in the form of droplets so that certain excess material remains on the drum surface. Said excess material is subsequently pushed back into the apertures during the course of the 360° rotation through the use of so-called spatulas, which are heated, before the material is shaped anew into droplets at the area of discharge.

There are also known devices for a portion-wise release of flowable masses (EP 0 511 197 B1), which is devoid of a spatula or a scraper to clean the smooth surface of the rotating drum since the actual discharge openings for the mass to be extruded have been relocated in this device to an outer proposed cylinder surface, which has a larger diameter than the one of the drum cover, whereby said outer cylinder surface extends concentrically relative to the drum cover and which has projections, e.g. in the shape of truncated cones or truncated pyramids, which are separated by valleys that reach the drum cover. Cleaning of the outer surface of the drum is unavoidable, which can be performed there with the aid of comb-shaped spatulas that reach into the valleys extending in circumferential direction. However, valleys that do not extend in circumferential direction but extend along the respective cover lines, cannot be cleaned in this manner so that devices of this type have certain disadvantages during operation.

### SUMMARY OF THE INVENTION

The present invention is based on the object to design a device of the aforementioned type in such a manner that excess material of adhering material is avoided from the start as much as possible so that cleaning of the drum cover surface can be eliminated to a great extent. In any case, the cylindrical cover surface is to be maintained as a circumferential surface of the drum, which is necessary for scraping or for the arrangement of a spatula.

For the achievement of this object it is proposed, according to the invention, that each of the many apertures, which reach the cylindrical circumferential surface of the drum cover, are surrounded by a groove-type recess whose sides form an encompassing tear-off edge together with the aperture at its end region. A tear-off edge is created through this design at each end of each aperture, which is configured in a way whereby the extruded material is released from the rotating drum almost completely and whereby almost no excess material remains on the drum cover. Small amounts of excess material still adhering to said drum cover are returned back into apertures and recycled during the rotation of the drum with the use of the above-mentioned spatula, and said excess material is subsequently fed along the groove wall facing the aperture to the discharge opening whereby said excess material is released together with the extruded material. Such a device ensures a relatively simple and thorough cleaning of the outer surface of the drum and provides an improved droplet-release process.

In development of the invention, the tear-off edge can be designed as a pointed and sharp tear-off edge whereby the side leading to the rear-off edge and the wall of the groove-shaped recess facing the opening form an angle that is smaller or equal to 75(and whereby said tear-off edge consists of the cylindrical inner wall of the discharge opening and the wall of the groove-shaped recess facing the opening. In an especially preferred embodiment, the openings themselves can be shaped circular so that the recess is formed as an annular groove in a simple manner.

In development of the invention, the cross section of the annular groove can be designed triangular with its base line aligned with the cover surface of the drum and having a third corner oriented toward the inside. The triangle forming the cross section can be an equilateral triangle and it is possible that the cross section of the annular groove is rounded at the lowest point.

In development of the invention, it is also possible to design the annular groove with different wall angles or to form the cross section parabolic or semicircular.

Such a device for extruding a flowable mass, which is usually identified as a so-called rotor drop shaper, can be manufactured in an especially advantageous manner with a rotating cutting tool whose face contour corresponds to the shape of the groove and which is provided with a center shank that is inserted respectively into the radially extending apertures of the perforated drum. It can be proposed thereby that the tool provided for boring of the apertures of the perforated drum can also be designed as a cutting tool to manufacture the annular groove around said apertures.

### DESCRIPTION OF THE DRAWINGS

The invention is illustrated in the drawing with the aid of an embodiment example and is explained in the following

FIG. 1 shows a partially cut-away, front view of a novel device for extruding a flowable mass in the form of a so-called rotor drop shaper;

FIG. 2 shows the schematic and enlarged illustration of the section through the rotor drop shaper according to FIG. 1 along the line II-II whereby the parts lying behind the sectional plane are not shown for reasons of clarity;

FIG. 3 shows an enlarged illustration of a longitudinal section through the sides of the rotatable drum in FIG. 2 in which can be seen the discharge openings and the groove encompassing the ends of said openings;

FIG. 4 shows a schematic top view onto three of the apertures of the drum as it is shown in FIG. 3;

FIG. 5 shows a perspective partial view of the circumferential surface of the rotatable drum of FIG. 1 and FIG. 2;

FIG. 6 shows a schematic illustration of a tool to manufacture annular grooves around the discharge openings shown in FIG. 3 through FIG. 5;

FIG. 7 shows a tool that is similar to the one in FIG. 6 but having a different configuration;

FIG. 8 shows a modified shape of the annular groove around a discharge opening compared to FIG. 3;

FIG. 9 shows an additional version of an annular groove.

### DETAILED DESCRIPTION OF A PREFERRED EMBODIMENT OF THE INVENTION

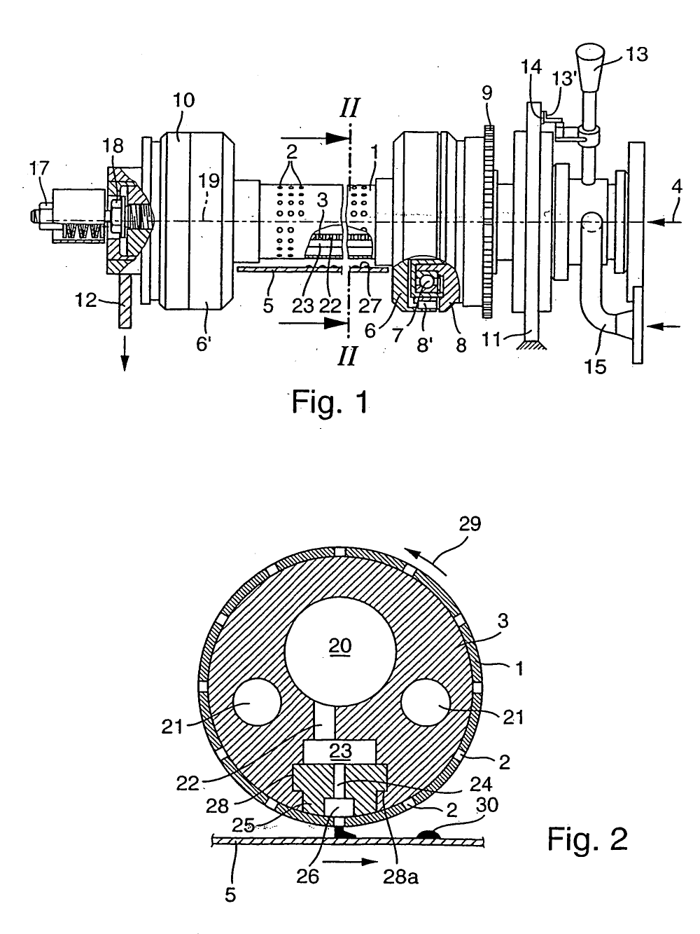

A so-called rotor drop shaper is illustrated in FIG. 1 whose effective part serves to extrude and portion a flowable mass consisting of an outer cylinder drum 1, which is provided over the entire circumference with apertures 2 and an inner container 3 into which the mass to be dropped is fed axially from the outside, specifically in the direction of the arrow 4, as it is shown in detail in FIG. 2. Said mass is pushed out through the apertures 2 onto a passing cooling belt that is facing the outer drum-shaped tube 1 whereby said mass is released in form of droplets onto the belt 5 and whereby said droplets subsequently solidify either through cooling or through another method.

As one can easily see in FIG. 2, the individual apertures, which are arranged respectively in axially-running rows on the cover of the drum 1, pass a through-going chamber 26, one after the other, during rotation of the drum 1 in the direction of arrow 29. Said chamber 26 is supplied under pressure with the material to be extruded, which is pushed through the axially extending feed channel 20, the connecting openings 22, an axially extending chamber 23 and through borings 24 leading from said chamber 23. The material being under a specific pressure in said chamber, which is a part of the pressing strip 25, is pushed out downwardly through the apertures and is then picked up by the belt 5 in the manner described above. The fixed inner body 3 of the rotor drop shaper is provided with heating ducts 21, which additionally help to properly heat the material to be extruded to reach the corresponding viscosity and the corresponding flowability for the droplet-releasing process. The pressing strip 25 abuts with lateral projections 28a the recess 28 of the inner body 3 so that said strip 25 is secured in a defined position relative to the rotating outer tube 1.

The outer drum 1 is provided at both ends with non-rotatable flanges 6, 6′ whereby flange 6 is connected with the help of a bearing 7 (not further illustrated) and via an adjustment wedge 8′ to a driven element 8, which communicates in turn with a toothed wheel 9. The flange 6′ is arranged in the same way in a bearing 10 that is secured within fixed support plates 11 or 12, particularly in the same manner as the driving element 8. The rotating drum 1 obtains in this way a defined and aligned position above the belt 5 that moves in a plane perpendicular to the plane of projection. The space between the drum 1 and the belt 5, which is designed as a cooling belt, can be adjusted with the aid of a manual lever 13 with which the inner container can be adjusted relative to the base plate 11 whereby a scale arranged on the plate 11 serves for its adjustment. The inside of the container 3 is axially fed with the substance to be extruded, as already indicated above, and there is also supplied a heating medium through the duct 15, in particular. This heating medium can be discharged again on the other side in a manner not further illustrated.

The outer drum 1 can be axially pulled from the inner container 3. This can be done after loosening the nuts 17 or 18 whereby said pulling-off in the direction of axis 19 is performed for the purpose of inserting another drum, for example.

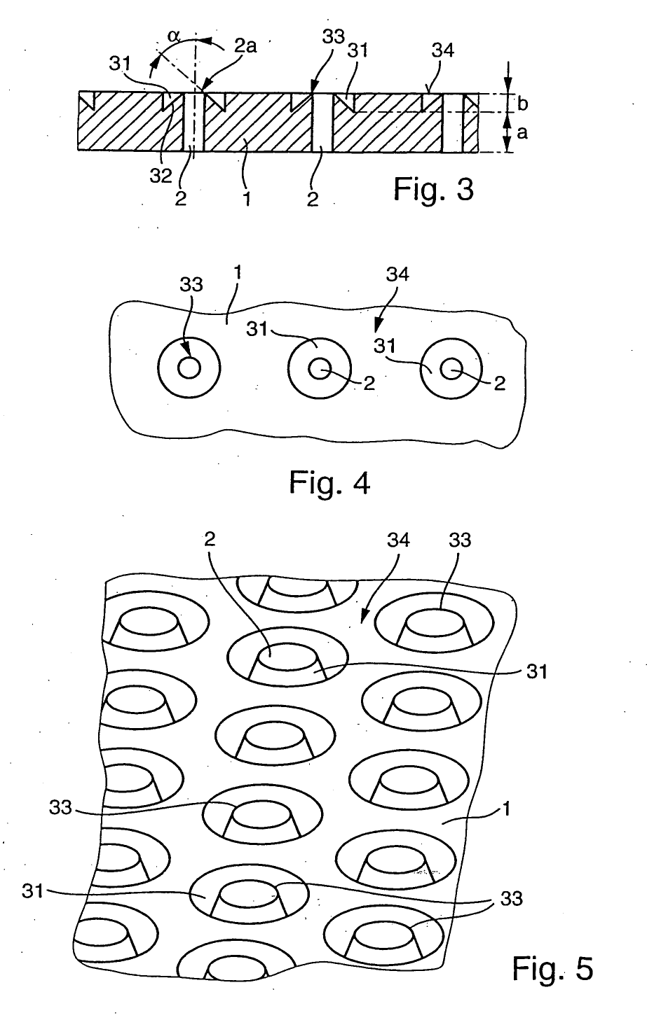

According to FIG. 3, apertures 2 are now designed respectively as cylindrical borings leading through the cover of the drum extending radially relative to the drum axis. The end 2a of each aperture is encompassed by a continuous annular groove 31, which is provided with a triangular cross section in the illustrated embodiment example whereby the base area of the equilateral triangle is a groove wall 32 lying at an angle to the end 2a whereby said groove wall 32 forms a sharp edge 33 at the end 2a together with the cylindrical wall of the aperture 2, and whereby said sharp edge 33 serves as a tear-off edge when the material to be extruded is pushed through the aperture 2 toward the outside and to the end 2a of the opening. It can be seen that the tear-off edges 33 are oriented upwardly relative to the observer in FIG. 3 and FIG. 5, and the ends 2a of the practical embodiment example shown in FIG. 1 and FIG. 2 are oriented downwardly toward the belt and they are fed with material from chamber 26. The tear-off edges 33, which are oriented downwardly for the droplet-producing process, prevent thereby that material can cling to the edge during the droplet-releasing process according to FIG. 2 and that excess material can reach the cylindrical surface 34 and soil the same. Should excess material remain adhered to the tear-off edge 33, it is received by the groove 31 during rotation of the drum 1 and it can still be pushed back into these grooves with the use of a known scraper or a push-in spatula. Said excess material can subsequently be pushed up on the wall 32 when it reaches the feed region in the area of the chamber 26 and it can be dropped again together with the extruded material.

The novel embodiment has the advantage that the outer circumference of the drum 1 remains cylindrical all the time and that the ends 2a do not project past the cylindrical outer surface—or they possibly lie radially somewhat under said surface if this is required by the manufacturing process, which will still be described later on. The outer surface of the drum remains therefore smooth to a great extent and known heated spatulas can be used, which keep the surface of the drum clean during operation.

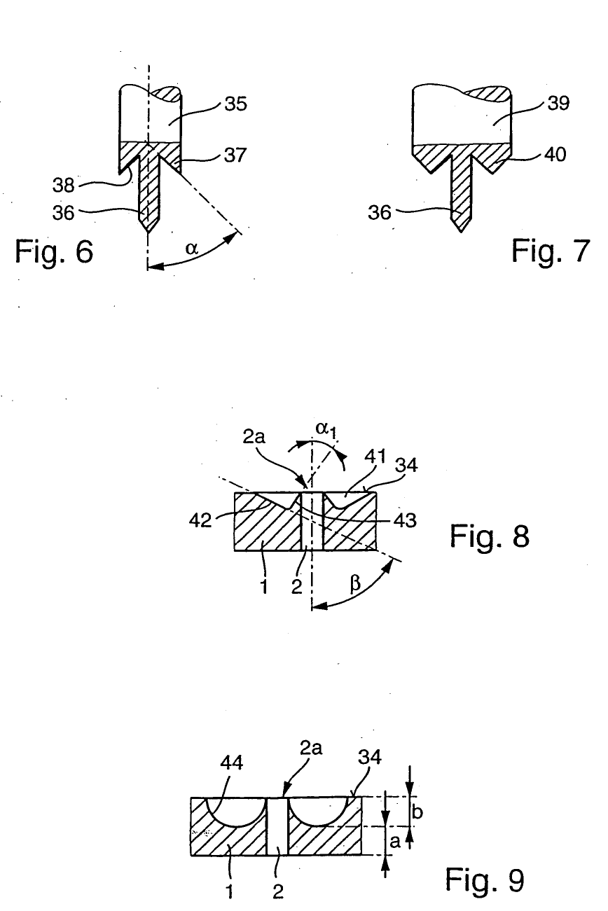

FIG. 6 shows now a possibility for manufacturing of drums 1 as they are shown in FIG. 3 through FIG. 5. FIG. 6 shows a cutting tool 35 provided with a center shank 36, which is provided with a contour on its face that is the negative to the grooves 31. The encompassing projection 37 has therefore an inner side 38 facing the shank 36 that is slanted at the angle (relative to the axis of the tool. Said surface 38 forms then the groove wall 32 during machining when the shank 36 is inserted into the aperture 2 of FIG. 3 and the cutting tool 35 is put into rotation, while the outer side of the tool 35 shapes the radial wall of the groove. In this way, it is made possible in a very simple manner to manufacture the encompassing grooves 31 concentrically to the borings 2 and to make possible that the tear-off edge 33 is created on the respective end 2a. Of course, it would also be possible to design the shank 36 as a boring tool and to bore at first the aperture 2, which is subsequently provided with the encompassing groove 31 in the same manufacturing step.

FIG. 7 shows a modified tool 39 provided also with the center shank 36; however, it has a projection 40 whose contour differs from the one of the groove 31. With such a tool 39, there can also be formed a groove that corresponds to a cross section of an equilateral triangle. The right angle lies here naturally at the bottom of the groove and not on its top, as it is the case in FIG. 3.

FIG. 8 clearly shows that the projection 40 could also be designed in a way whereby a groove 41 is created that has the sides 42 and 43 slanted at different angles (1 or (relative to the center axis of the boring of the aperture 2. The transition between the sides 42 and 43 is rounded. Such a groove can also be manufactured with a tool similar to the one in FIG. 7 whereby the encompassing projection 40 must, however, correspond to the negative contour of the groove 41.

FIG. 9 shows an additional version that is also possible. A groove 44 encompassing the end of the aperture 2 is here provided with a roughly semicircular cross section whereby the cross section may be only a segment of a full circle. Said groove 44 is provided with a depth b which can be selected to be equal to the remaining material thickness a of the drum 1; of course, other relationships can be realized as well and which can after all also apply to the groove 31 and 41. The deciding factor in all embodiments is the fact that the end 2a of each aperture 2 does not project outwardly past the circumferential surface 34 of the drum 1.

1-9. (canceled).

10. Apparatus for extruding a flowable mass into the shape of droplets, comprising a rotatable cylindrical drum and a mass-conducting structure disposed within the drum for conducting the flowable mass to a lower feed space of the drum's interior; the drum including a plurality of substantially radial apertures arranged to become intermittently aligned with the feed space as the drum rotates, to enable the mass to flow through the apertures; each aperture including a radially outer end disposed at a cylindrical outer surface of the drum and substantially surrounded by a groove formed in the outer surface, a side of each groove substantially intersecting the respective aperture to form therewith a tear-off edge for promoting release of the mass from the drum.

11. The apparatus according to claim 10 wherein a side of each groove disposed closest to the respective aperture is inclined generally radially outwardly toward the radially outer end of the aperture.

12. The apparatus according to claim 11 wherein the tear-off edge is sharp.

13. The apparatus according to claim 12 wherein the apertures are circular in cross section, and the grooves are annular.

14. The apparatus according to claim 13 wherein each groove has generally triangular cross sectional shape as seen in a plane oriented perpendicularly to a rotary axis of the drum, wherein one side of the triangular shape is aligned with the outer surface of the drum.

15. The apparatus according to claim 14 wherein the triangular shape is substantially that of an equilateral triangle.

16. The apparatus according to claim 13 wherein each groove as seen in a cross sectional plane oriented perpendicular to a rotary axis of the drum, comprises two sides converging in a generally radially inward direction and joined at their inner ends by a curved portion.

17. The apparatus according to claim 13 wherein each groove has generally conical cross sectional shape as seen in a plane oriented perpendicularly to a rotary axis of the drum, wherein one side of the conical shape is aligned with the outer surface of the drum.

18. The apparatus according to claim 13 wherein each groove has generally semi-circular cross sectional shape as seen in a plane oriented perpendicularly to a rotary axis of the drum, wherein one side of the semi-circular shape is aligned with the outer surface of the drum.

19. The apparatus according to claim 10 wherein the tear-off edge is sharp.

20. The apparatus according to claim 10 wherein the apertures are circular in cross section, and the grooves are annular.

21. Apparatus for extruding a flowable mass into the shape of droplets, comprising a channel structure defining an inlet for receiving flowable mass, and a downwardly facing lower outlet for discharging the flowable mass; and a cylindrical drum mounted for rotation around the exterior of the conduit structure; the drum including a plurality of radial apertures, circular in cross section, arranged to become intermittently aligned with the outlet as the drum rotates, to enable the mass to flow through the apertures; each aperture including a radially outer end disposed at a cylindrical outer surface of the drum, and which is completely surrounded by an annular groove formed in the outer surface; a side of each groove being inclined toward the outer end of its respective aperture in a generally radially outer direction and forming together with the outer end of the aperture a generally sharp circular tear-off edge for promoting release of the mass from the drum.

22. A method of forming apertures in a cylindrical outer surface of a rotatable cylindrical drum of an apparatus for extruding a flowable mass into droplets, the apparatus comprising the drum and a mass-conducting structure disposed within the drum for conducting the flowable mass to a lower feed space of the drum's interior; the drum including a plurality of substantially radial apertures arranged to become intermittently aligned with the feed space as the drum rotates, to enable the mass to flow through the apertures; each aperture including a radially outer end disposed at a cylindrical outer surface of the drum and substantially surrounded by a groove formed in the outer surface; a side of each groove substantially intersecting the respective aperture to form therewith a tear-off edge for promoting release of the mass from the drum; the method utilizing a rotary cutting tool including a center shank and a cutting face disposed exteriorly of the shank, the cutting face having a contour shaped as the negative of an aperture's contour, the method comprising the steps of engaging the tool against a drum blank and rotating the tool about an axis defined by the center shank.

23. The method according to claim 22 further comprising the step of drilling an aperture through the drum prior to the engaging step, the engaging step including inserting the shank into the aperture and cutting the groove by the cutting face during rotation of the tool.

24. The method according to claim 22 wherein the aperture is cut by the shank and the groove is cut by the cutting face.
